(19) United States
(12) Patent Application Publication
(10) Pub. No.: US 2010/0318337 A1
(43) Pub. Date: Dec. 16, 2010

(54) METHOD, APPARATUS AND SYSTEM FOR MODELED CARBON SEQUESTRATION

(76) Inventors: William J. Bailey, Somerville, MA (US); Benoit Couet, Belmont, MA (US); Nadege Hopman, La Defense Cedex (FR); Laurent Jammes, Paris (FR); Hans Eric Klumpen, Windsor (GB); Gustavo Nunez, Baden (AT); Terizhandur S. Ramakrishnan, Boxborough, MA (US); Scott Trevor Raphael, Katy, TX (US); Richard Torrens, Calgary (CA); Sandeep Verma, Acton, MA (US)

Correspondence Address: OSHA LIANG L.L.P., TWO HOUSTON CENTER, 909 FANNIN, SUITE 3500, HOUSTON, TX, 77010, US

(21) Appl. No.: 12/761,368

(22) Filed: Apr. 15, 2010

Related U.S. Application Data
(63) Continuation-in-part of application No. 11/929,811, filed on Oct. 30, 2007.
Application No. 11/929,811 is a continuation-in-part of application No. 11/929,921, filed on Oct. 30, 2007.
(60) Provisional application No. 61/169,622, filed on Apr. 15, 2009.
(60) Provisional application No. 60/855,262, filed on Oct. 30, 2006.
(60) Provisional application No. 60/855,262, filed on Oct. 30, 2006.

(51) Int. Cl. G06G 7/48

(52) U.S. Cl. 703/10

(57) ABSTRACT

Methods, systems and apparatuses are provided for facilitating sequestration of naturally occurring or anthropogenic carbon dioxide. The methods, systems and apparatuses of the present invention include a software interface for facilitating an exchange of data among associated simulators which simulate various steps of the carbon sequestration process.

### CROSS REFERENCE TO RELATED APPLICATIONS

This application claims priority under 35 U.S.C. §119(e) from Provisional Patent Application Ser. No. 61/169,622 filed Apr. 15, 2009, and is also a continuation in part of co-pending applications initially filed as U.S. Provisional Patent Application No. 60/855,262 filed Oct. 30, 2006, subsequently filed as U.S. application Ser. No. 11/929,811 and U.S. application Ser. No. 11/929,921, both filed Oct. 30, 2007, and entitled “System and Method for Performing Oilfield Simulation Operations” and of International Application No. PCT/US2007/83070 and International Application No. PCT/US2007/83072, both also filed Oct. 30, 2007, having the same title.

### FIELD OF THE INVENTION

This invention relates to improved methods and systems for use in carbon sequestration. In particular, the invention provides methods, apparatuses and systems for more effectively and efficiently assessing risks associated with carbon sequestration, developing a plan to optimize the risks and implementing one or more steps of the plan.

### BACKGROUND OF THE INVENTION

Addition of carbon dioxide (CO₂ to be proper, but also referred to herein for ease of formatting as “CO2”) to the atmosphere, for example by burning fossil fuels such as oil, natural gas and coal, is believed to contribute to global warming. Exhausts from petrochemical and other manufacturing plants may also be sources of CO2 additions to the atmosphere. Of course, one could collect the CO2 for commercial use or use it to enhance agricultural production in greenhouses. But sequestering CO2, that is, placing and storing CO2 at a location where the CO2 cannot enter the atmosphere, is a way of mitigating the possible adverse effects of additions of CO2 to the atmosphere. Carbon dioxide sequestration is also referred to as “carbon sequestration.” Carbon capture and storage (CCS) is capture and isolation of carbon dioxide from high carbon-emitting sources, such as power plants, and storage or sequestration in a location where the carbon dioxide will not enter the atmosphere.

One could sequester CO2 using a number of methods and locations. CO2 may be sequestered by placing the CO2 in the depths of the ocean (unless there are unacceptably adverse effects on ocean life) or in the sub-ocean floor such as in basalt formations. But one could also inject the CO2 into underground formations. For example, one could inject CO2 underground in deep saline reservoirs or in depleted hydrocarbon (oil and/or natural gas (gas)) reservoirs. One could inject CO2 into underground coal beds (displacing natural gas, which may then be produced) or into peridotite formations. One could use the CO2 for enhanced oil recovery (EOR) or enhanced gas recovery (EGR) by injecting the CO2 via one or more injection wells into reservoirs containing hydrocarbons and using the CO2 to facilitate mobilization of the hydrocarbons towards one or more producing wells.

A “formation” is a “body of rock that is sufficiently distinctive and continuous that it can be mapped.” (This and other definitions in this paragraph are taken from the Schlumberger Oilfield Glossary (“Glossary”), available online at www.glossary.oilfield.slb.com). Underground formations are comprised of rock which, in turn, are composed of rock grains (of one or more minerals) and pore spaces. (Coal is an exception to this general rule as it is a rock composed of organic material, not minerals which are inorganic.) An underground reservoir is an underground formation “with sufficient porosity and permeability to store and transmit fluids.” A formation suitable for CO2 sequestration would likely be a reservoir (though that might be arguable in the case of a coal seam), but the terms are sometimes used interchangeably. Porosity of a formation is the percentage of space (pores) between the rock grains of the formation, space which may contain fluids (liquids, condensates or gases). Permeability is a measure of how well a rock of a formation allows fluids which occupy the pore space of the rock to flow through the rock. Fracturing, if carefully performed so as not to disturb the trapping mechanism of the reservoir, might be used to enhance injectivity.

Selecting appropriate reservoirs for sequestration pose special challenges. The reservoir would have to have adequate capacity for storage of the desired amount of CO2. The reservoir should have one or preferably more trapping mechanisms to keep the CO2 in place and prevent its migration to the surface. The CO2 may also react to rocks or minerals in the formation and stabilize and become affixed in place.

Analysis of the formation, its composition, porosity and permeability, as well as other characteristics and surrounding lithology, may be important to the selection of an underground formation in which to sequester CO2. The storage formation should be placed with respect to other, preferably impermeable formations so that the CO2 would be trapped within the sequestration formation and not be able to migrate through other formations to the surface. The underground storage formation selected should have sufficient porosity to receive the desired volume of CO2 to be sequestered and should have sufficient permeability so that the CO2 may be injected into the formation and flow through the rock of the formation. (Though as noted above, fracturing, if carefully performed so as not to disturb the trapping mechanism of the reservoir, might be used to enhance injectivity.) Adverse reactions of the CO2 with minerals in the storage formation would preferably be minimized, either by selecting storage formations without minerals the CO2 would likely adversely react with or by taking other steps to minimize such reactions or minimize their adverse effects. On the other hand, it would be advantageous to have a storage formation with minerals that help the CO2 to become affixed in place, such as by crystallizing in place, to minimize or prevent the possibility of the CO2 leaking either to the surface and into the atmosphere or into formations bearing potable water.

In addition, the environment of an underground reservoir used for carbon sequestration might have high temperatures or pressures or have other hazards such as hydrogen sulfide, which might provide challenges to the material selection, well construction and/or placement process. CO2 combined with water can form carbonic acid, which could damage some conventional materials that might be used to transport, place or contain the CO2, so material selection is important.

One may want to prepare surface of the sequestration location in such a way that any leakage of CO2 to the surface after placement is easily detectable and/or mitigated. It is desirable that the site be properly decommissioned after a preferably optimum amount of CO2 is in place and the site monitored for sometime afterwards to ensure that the CO2 placement is stable. It is desirable to ascertain the amount, location and state of the CO2 during the placement process, after the CO2 has been placed and for some period thereafter. Post-decommissioning monitoring may be required by regulatory agencies.

Cost is a consideration throughout the process. Budgets may have to be prepared which make provision for investigating possible sequestration sites, acquiring rights to the desired sequestration site, capturing and treating the CO2, transporting the CO2 if necessary, constructing surface facilities and injection wells, monitoring and measuring the CO2, operating the site, decommissioning the site, posting a bond if necessary to cover any post-decommissioning problems, and monitoring the CO2 after decommissioning the site until the CO2 is determined to be in a stable state of sequestration. Obtaining proper permission from governmental bodies and owners of the space in the reservoir must also be accomplished as part of the process.

There are also many challenges with carbon sequestration that involve the collection, isolation, transport, measurement, placement and post-placement of the CO2. CO2 may have to be isolated, dried and/or collected, for example from the exhaust of power plants or other high volume sources of CO2. CO2 may be compressed for transportation. One could sequester CO2 while in a gaseous state but it would generally be preferable to do so while the CO2 is in a supercritical fluid state or phase, at temperatures above 31.2° C. and pressures above 72.8 atmospheres. CO2 is generally stored in supercritical phase for efficiency reasons. CO2 in a supercritical phase can be very dense which allows more CO2 (in mass units) to be injected into a defined pore space in a formation. Accordingly, CO2 may have to be converted from a gaseous state to a supercritical liquid state. On the other hand, CO2 may also be sequestered in some other state, for example, as a CO2-saturated brine.

In some cases, CO2 may be sequestered close to where it is produced, but in many cases, the CO2 may have to be transported some distance to a suitable sequestration site. Measurement of the CO2 may be needed at different points in the process. One may have to provide for buffering the CO2 (storing the CO2 temporarily, for example, in properly constructed vessels at a surface location) to allow for periods of down-time or disruption in the sequestration process.

There are many sources of CO2 but they can be loosely divided into naturally occurring CO2 (such as CO2 which may be produced along with hydrocarbons in an oil or gas well) or “anthropogenic” CO2 which may be created by burning fossil fuels or by other man-made activities.

### SUMMARY OF THE INVENTION

One embodiment of the present invention provides a method of facilitating sequestration of naturally occurring carbon dioxide including simulating production of a fluid containing carbon dioxide through an underground reservoir to a production well using a reservoir simulator; simulating production of a fluid containing carbon dioxide from the reservoir to the surface through a production well using a flow simulator; simulating separation of the CO2 from the fluid produced using a process simulator; simulating processing such as compression and dehydration of carbon dioxide at the surface using a process simulator; simulating transport of carbon dioxide from the surface through an injection well and into an underground formation using a second flow simulator; providing economic analysis for all the above activities including carbon sequestration process using an economics modeler; and facilitating an exchange of data among one or more of the reservoir simulator, flow simulator, economics modeler, process simulator and second flow simulator using a software interface.

One embodiment of the present invention provides a method of facilitating sequestration of anthropogenic carbon dioxide including providing economic analysis for the carbon sequestration process using an economics modeler; simulating production, processing and movement of carbon dioxide at the surface using a process simulator; simulating transport of carbon dioxide from the surface through an injection well and into an underground formation using a flow simulator; and facilitating an exchange of data among one or more of the economics modeler, process simulator and injection flow simulator, using a software interface. One or more advantages of the present invention may become apparent to those of skill in art by reference to the figures, the description that follows and the claims.

### BRIEF DESCRIPTION OF THE DRAWINGS

FIG. 1 is a conceptual-level depiction of CO2 generation and sequestration.

FIG. 2 is a flowchart for a generalized CO2 sequestration process.

FIG. 3 is a flowchart for a CO2 sequestration process, including an embodiment of the instant invention.

FIG. 4 is a depiction of the CO2 production and sequestration process for naturally occurring CO2, in accord with one embodiment of the present invention.

FIG. 5 is a depiction of the CO2 production and sequestration process for anthropogenic CO2, in accord with one embodiment of the present invention.

FIG. 6 is a depiction of a representation of an example of a carbon sequestration process involving naturally occurring CO2.

FIG. 7 is a representation of use of one embodiment of the present invention (including commercially available software components) in the carbon sequestration example of FIG. 6.

FIG. 8 is a representation of the embodiment of the present invention depicted in FIG. 7

FIG. 9 is a diagram of a computer system in accordance with one or more embodiments of the invention.

### DETAILED DESCRIPTION OF THE DRAWINGS

In the following detailed description of a preferred embodiment and other embodiments of the invention, reference is made to the accompanying drawings. It is to be understood that those of skill in the art will readily see other embodiments and changes may be made without departing from the scope of the invention.

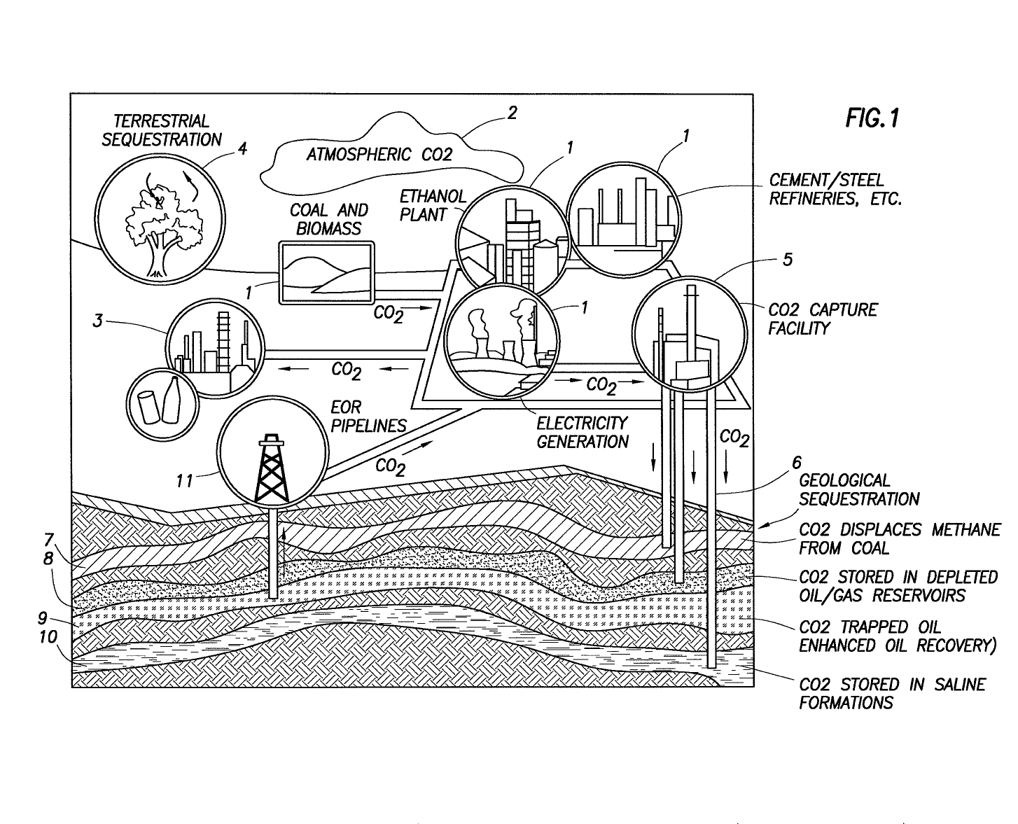

FIG. 1 is a conceptual-level depiction of CO2 generation and sequestration. Large-scale CO2 sources 1, for example, ethanol plants, cement factories, steel factories, refineries, electricity generation plants, coal and biomass operations generate CO2 and usually vent it as atmospheric CO2 2. Some large scale CO2 sources may transport the CO2 to factories 3 where the CO2 can be used for industrial processes or for food and drink products. Some CO2 is sequestered through natural processes such as from trees 4 “inhaling” CO2 and “exhaling” O2 (oxygen). But CO2 may be taken to a CO2 capture facility 5, where the CO2 is processed and then geologically sequestered. In geologic sequestration, the CO2 is injected down one or more wells 6 and into an appropriate formation, such as a coal seam 7 where the CO2 can displace methane to a production well 11 by which the methane can be produced. Another appropriate formation might be a suitable depleted oil and/or gas reservoir 8. Another appropriate formation might be a suitable reservoir with trapped oil 9 that the CO2 may be used to displace to a production well 11 by which the oil may be produced. Another appropriate formation might be a saline reservoir 10 with a suitable trapping structure. Other appropriate formations would be known to those of skill in the art.

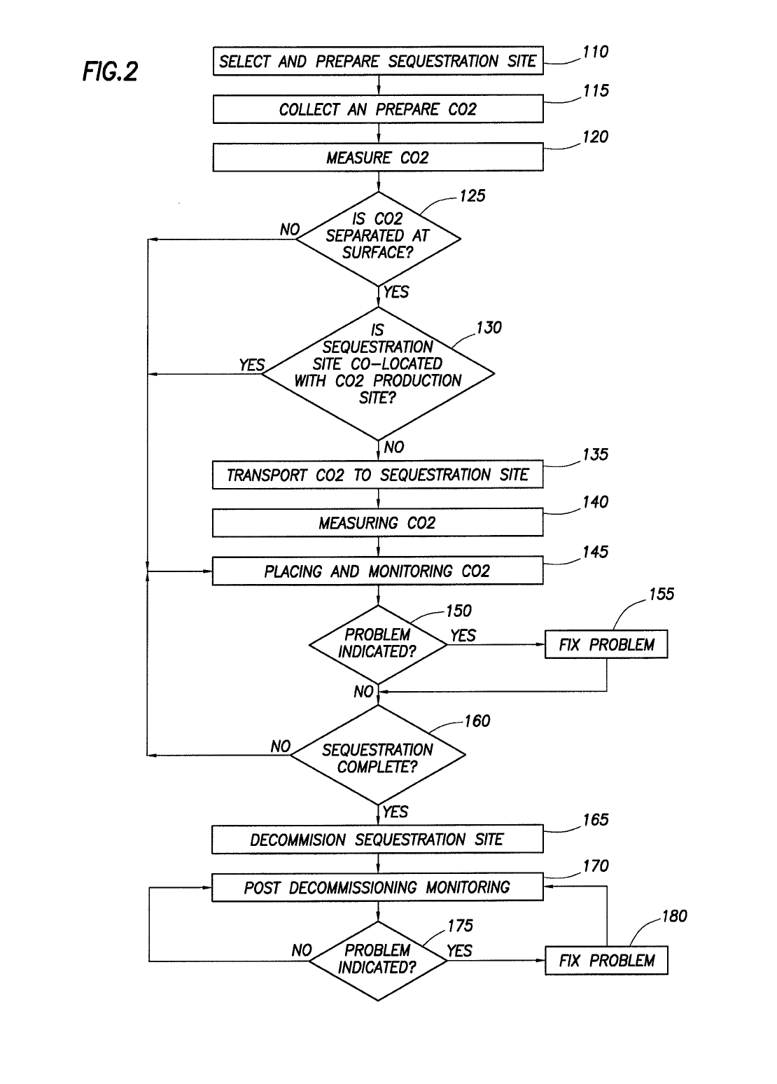

FIG. 2 is a depiction of an overview of a CO2 sequestration process, which may be used with or without embodiments of the instant invention. One selects and prepares 110 a sequestration site. This may be a lengthy and involved process involving many steps and considerations. One consideration might be whether the CO2 can be separated underground (which might be possible if produced with hydrocarbons) or whether it must be separated at the surface. If the CO2 is being collected at the surface, a determination would be made as to whether there was a place to sequester the CO2 onsite or whether the CO2 might have to be transported to another site. If transportation is necessary, the possible sites available would be considered along with their relative advantages and disadvantages.

Referring again to FIG. 2, CO2 is collected and prepared 115 for storage. How the CO2 is collected and prepared depends in part on the source of the CO2. The source of the CO2 may be a power plant, refinery, factory or other industrial site or the source of the CO2 may be from hydrocarbon production. There are countless sources of CO2, including every human being and animal on the planet and most automobiles, but carbon sequestration is currently most practical where the CO2 is produced in large amounts and can be easily collected. The source of the CO2 helps to determine whether the CO2 requires processing, such as removal of moisture or other contaminants before transportation and/or sequestration. (Removal of moisture or of contaminants may not be practical or advisable and the CO2 may in some cases be sequestered without such processing.) The CO2 may be measured 120 as and/or after the CO2 is collected and/or processed.

Referring again to FIG. 2, the process may be different, depending on whether the CO2 is separated at the surface 125 and whether the sequestration is co-located with the CO2 production site 130. If the CO2 is not separated at the surface but rather underground as it is produced, for example with hydrocarbons, it might be possible to have the CO2 placed and monitored 145 underground. In the more typical case of collecting and separating the CO2 at the surface, then a determination is made as to whether the selected sequestration site is co-located with CO2 production site. If the CO2 is co-located with the sequestration site the CO2 may still need to be transported a short distance and measured as part of being placed and monitored 145, but if the sequestration site is not co-located with the CO2 production site substantial transportation system 135, such as through a pipeline system, may be necessary. Compression of the CO2 may be necessary for transportation. Measurements 140 may have to be taken at several points to ascertain that there is no CO2 leakage occurring or to determine a location of any CO2 leakage or simply to determine the amount of CO2 at various points in the process.

Continuing to refer to FIG. 2, at the sequestration site, the CO2 is placed and monitored 145. Buffering may be provided to store CO2 in case the sequestration site has to be temporarily shut down. As monitored sequestration progresses, if problems are indicated 150, they are evaluated and ameliorated or if possible, completely fixed 155. Monitoring may be used to determine whether the sequestered CO2 is stable or whether the sequestered CO2 is becoming permanently affixed in the storage formation. Sequestration continues until complete 160. Completion might occur for example, if the source of the CO2 permanently shuts down or if the storage formation cannot accept any more CO2. Injection pressure would generally be limited to some conservative percentage of the fracture pressure of the reservoir, such as 70%, and there may be specific limits enacted in relevant legislation or regulation. The sequestration site would then be properly decommissioned 165 and post-decommissioning monitoring 170 might begin. If the post-decommissioning monitoring detects 175 a problem, the problem situation may have to be improved or fixed 180.

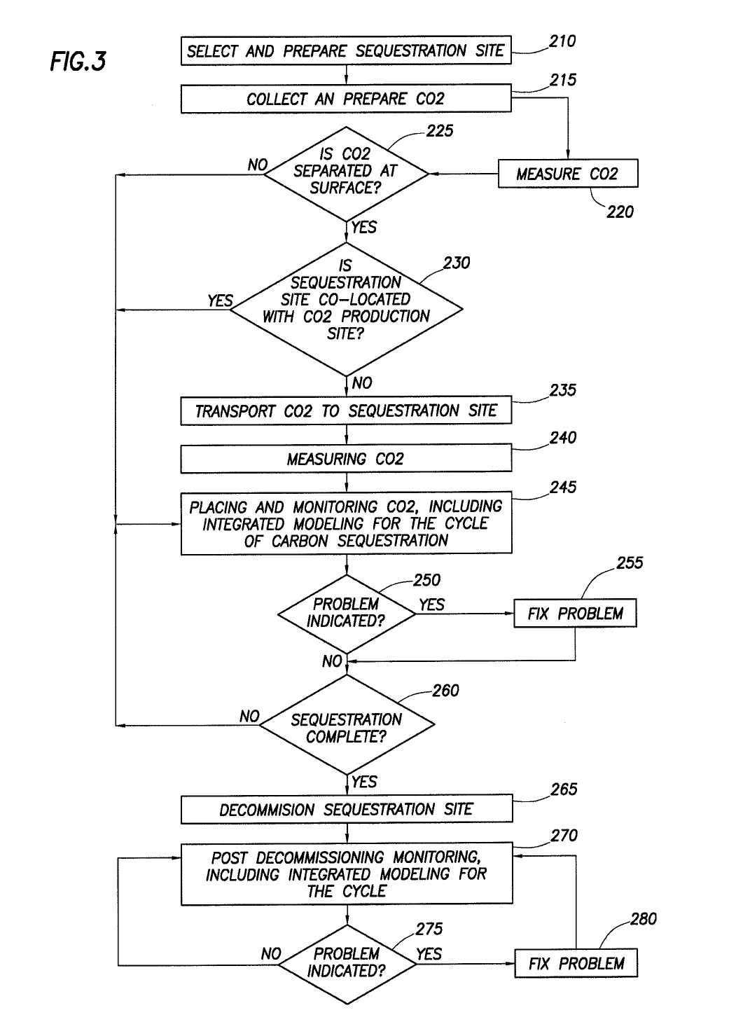

FIG. 3 is a flowchart for a CO2 sequestration process, including an embodiment of the instant invention. As with the general process presented in FIG. 2, one selects and prepares 210 a sequestration site. This may be a lengthy and involved process involving many steps and considerations. If the CO2 is being produced with hydrocarbons, the CO2 might be separated underground and be sequestered without reaching the surface. If the CO2 is being collected at the surface, a determination would be made as to whether there was a place to sequester the CO2 onsite or whether the CO2 might have to be transported to another site. If transportation is necessary, the possible sites available would be considered along with their relative advantages and disadvantages.

Referring again to FIG. 3, as presented in FIG. 2, CO2 is collected and prepared 215 for storage. The CO2 may be measured 220 as and/or after the CO2 is collected and/or processed.

Referring again to FIG. 3, as discussed with respect to FIG. 2, the process may be different, depending on whether the CO2 is separated at the surface 225 and whether the sequestration is co-located with the CO2 production site 230. If the CO2 is not separated at the surface but rather underground as it is produced, for example with hydrocarbons, it might be possible to have the CO2 placed and monitored 245 underground. In the more typical case of collecting and separating the CO2 at the surface, then a determination is made as to whether 230 the selected sequestration site is co-located with CO2 production site. If the CO2 is co-located with the sequestration site the CO2 may still need to be transported a short distance and measured as part of being placed and monitored 245, but if the sequestration site is not co-located with the CO2 production site substantial transportation system 235, such as through a pipeline system, may be necessary. Measurements 240 may have to be taken at several points to ascertain that there is no CO2 leakage occurring or to determine a location of any CO2 leakage or simply to determine the amount of CO2 at various points in the process.

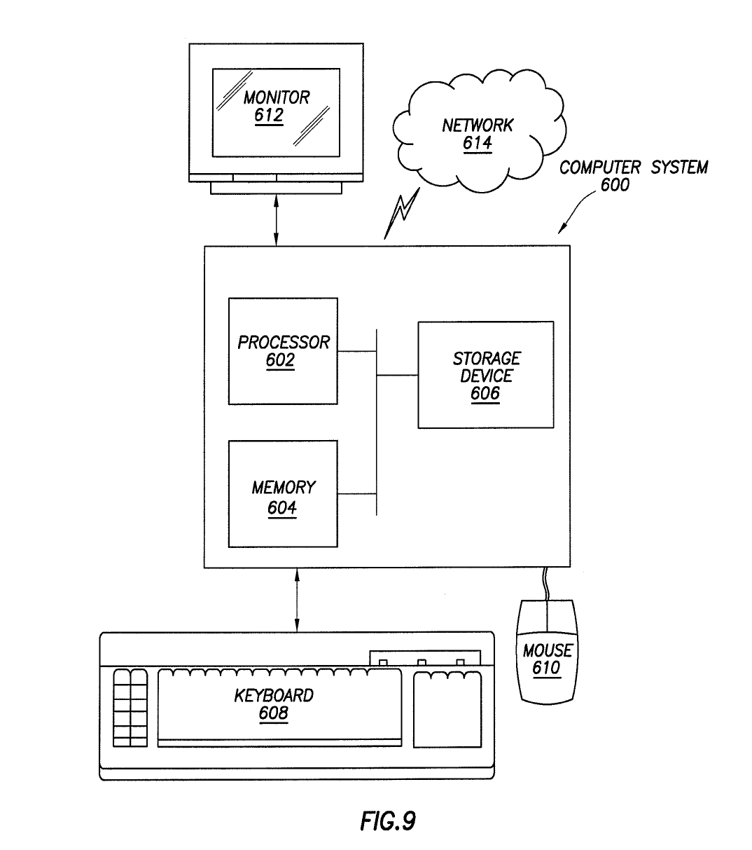

Continuing to refer to FIG. 3, at the sequestration site, the CO2 is placed and monitored 245, with a monitoring system in accordance with an embodiment of the present invention which includes use of a software interface to facilitate an exchange of data among two or more of a reservoir simulator, a flow simulator, an economics modeler, a process simulator, and/or an injection flow simulator. Those skilled in the art will appreciate that each of the reservoir simulator, the flow simulator, the economics modeler, the process simulator, and/or the injection flow simulator may be implemented on a computer system as described below with respect to FIG. 9.

A software interface, such as Avocet IAM, is used in an embodiment of the invention to facilitate integrated modeling of the carbon sequestration process. Avocet IAM is a commercially available Schlumberger software for oil and gas operations which integrates reservoir, well, surface network and process facility models into a single decision making framework for operations and planning users. Avocet IAM provides valuable production rate information and economic predictions across the entire asset and for the entire asset life. The present invention provides in part an adaptation of a software interface such as Avocet IAM (also known as Avocet Integrated Asset Modeler) so that it can be used in a process to model either naturally occurring CO2 production and sequestration or CO2 production and sequestration process for anthropogenic CO2 or both. One embodiment of the present invention uses a software interface, such as Avocet IAM, to create an interface between one or more various software programs (reservoir modeling which may include phase behavior, flow in wells and pipes; plant systems, and economics evaluation) to allow them to communicate among each other. An embodiment of the present invention so configured to be used for example to predict elevation or subsidence or to determine other things including but not limited to whether sequestered CO2 has become affixed in a sequestration reservoir, whether there has been aquifer contamination or leakage of CO2 to the surface. If problems are detected, steps may be taken to fix the problem and/or improve the problem situation. If inefficiencies are detected, steps can be taken to improve efficiencies.

With this new application of a software interface, such as AVOCET IAM (the best selection the inventors are aware of), it is possible to build a workflow that models the fate of CO2 from its production (anthropogenic or natural) to its injection for sequestration. Patent applications pertinent to AVOCET have been previously filed and are incorporated herein by reference: US Patent Publication No. 20080103743(A1), 20080133194(A1), 20090012765(A1), and 20080262802(A1).

Continuing to refer to FIG. 3, placement of the CO2 is preferably in an appropriate formation having properties allowing the formation to safely receive and store the CO2, as previously discussed herein. Buffering may be provided to store CO2 in case the sequestration site has to be temporarily shut down. As monitored sequestration progresses, if problems are indicated 250, they are evaluated and ameliorated or if possible, completely fixed 255. Monitoring may be used to determine whether the sequestered CO2 is stable or whether the sequestered CO2 is becoming permanently affixed in the storage formation

Continuing to refer to FIG. 3, sequestration continues until complete 260. Completion might occur for example, if the source of the CO2 permanently shuts down or if the storage formation cannot accept any more CO2. The sequestration site would then be properly decommissioned 265 and post-decommissioning monitoring 270 might begin. The post-dimensioning monitoring system may, in accordance with an embodiments of the present invention, a monitoring system in accordance with an embodiment of the present invention which includes use of a software interface to facilitate an exchange of data among two or more of a reservoir simulator, a flow simulator, an economics modeler, a process simulator, and/or an injection flow simulator. If the post-decommissioning monitoring detects 275 a problem, the problem situation may have to be improved or fixed 280.

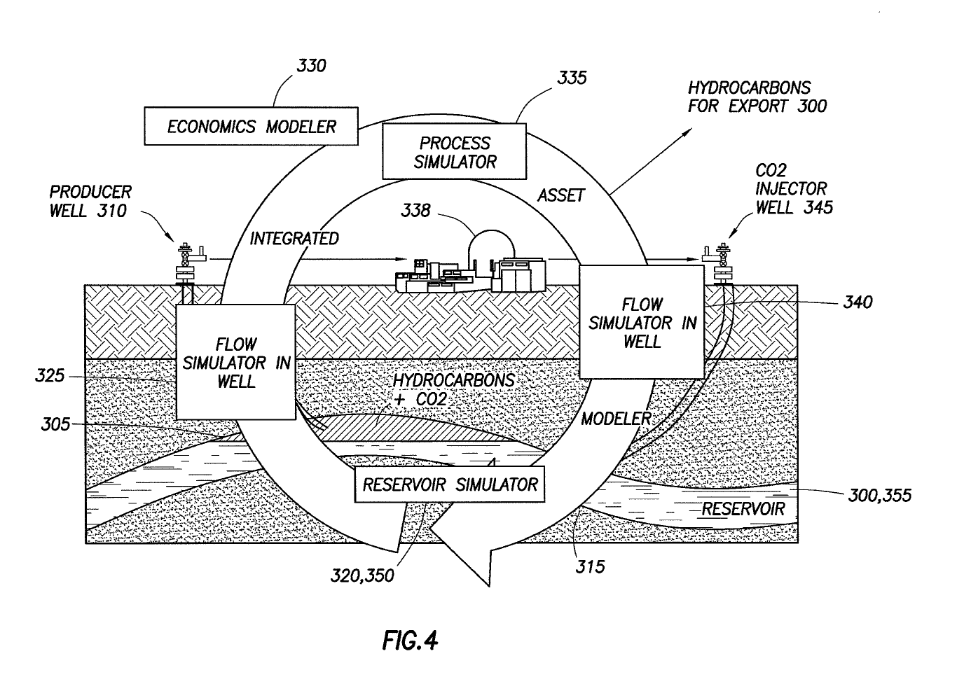

FIG. 4 is a depiction of the CO2 production and sequestration process for naturally occurring CO2, in accord with one embodiment of the present invention. In the situation of naturally occurring CO2, a reservoir 300 having a production interval 305 with hydrocarbon and carbon dioxide is intersected by a producer well 310, through which the hydrocarbon and CO2 is produced to the surface. A software interface 315 (such as Avocet IAM) is provided to facilitate an exchange of information among 1) a first reservoir simulator 320 which simulates production of production fluid including CO2 (most commonly with one or more other fluids such as gas or oil) through a producing reservoir; 2) a flow simulator 325 which simulates the production fluid being produced from the producing reservoir through a production well to the surface and to an upstream surface production facility (not depicted in FIG. 4); 3) an economics modeler 330; 4) a process simulator 335 for simulating processing of the production fluid throughout the upstream surface production facility where CO2 would preferably be separated from most other components of the production fluid and for further processing of CO2 at a carbon dioxide processing facility 338; 5) an injection flow simulator 340, for modeling transport of CO2 from the surface through an injection well 345 and to a sequestration reservoir and 6) a second reservoir simulator 350 for modeling the injection and the fate of the CO2 in the sequestration reservoir. In addition to the first reservoir simulator 320, a reservoir modeler which models the geological structure of the reservoir may be used. If CO2 (with or without other fluids) is transported at the surface, either from the well to the upstream surface production facility, and/or from the upstream surface production facility to a carbon processing facility and/or from a carbon processing facility to an injection well, a transportation simulator (not depicted in FIG. 4) such as PIPESIM may be used. Instead of a single process simulator 335, alternatively a first process simulator (not depicted) could be used for simulating the processing of the production fluid throughout the upstream surface production facility where CO2 would preferably be separated from most other components of the production fluid and a second process simulator 335 could be used to simulate further processing of CO2 at a carbon dioxide processing facility 338. Those skilled in the art will appreciate that each of the first reservoir simulator 320, the second reservoir simulator 350, the flow simulator 325, the economics modeler 330, the process simulator 335, and/or the injection flow simulator 340 may be implemented on a computer system as described below with respect to FIG. 9.

Specially written software could be used for the simulators and modeling software discussed in the paragraph above, but commercially available software may also be used. To give examples, for the first and second reservoir simulators 315, 350, commercially available software such as FrontSim or ECLIPSE (such as ECLIPSE E300 Dual porosity/permeability model) may be used. Both FrontSim and ECLIPSE are available from Schlumberger. Other commercially available reservoir simulators include Tough2, CMG, VIP, and STOMP. The flow simulator 325 may be commercially available software such as PIPESIM or HYSIS. For the economic modeler software 330 a properly configured Excel file could be used to perform this function. Alternatively, commercially available programs, such as PEEP, could be used as the economic modeler of an embodiment of the present invention if “other” is selected as a component when using PEEP, instead of selecting oil or gas as the component. The process simulator 335 may be commercially available software such as HYSIS. In addition to PIPESIM, other commercial software such as Aspen Plus, Pro II, HYSYS, Pro Max, Winsim could potentially be used as the transportation simulator (not depicted in FIG. 4).

The injection flow simulator 340 may be the same as the flow simulator used to model the CO2 being produced through the production well or the injection simulator may be different. As with the flow simulator, commercially available software such as PIPESIM or HYSIS could be used as the injection simulator. The sequestration reservoir 355 may be the same as the producing reservoir 300 (as depicted in FIG. 4) or the sequestration reservoir 355 may be a different reservoir, such as but not limited to a deep saline reservoir or a different depleted oil or gas reservoir. If the sequestration reservoir 355 is a different reservoir than the production reservoir 300, the sequestration reservoir 355 may be in the same oilfield as the production reservoir 300 or may be in different location, either in another oilfield or not in an oilfield. Similarly, the second reservoir simulator 350 used to model the sequestration of CO2 into and through the sequestration reservoir may be the same as the reservoir simulator used for simulating fluid and CO2 in the producing reservoir or the second reservoir simulator may be different. As with the reservoir simulator, commercially available software such as FrontSim or ECLIPSE could be used for the second reservoir simulator.

Use of the software interface such as AVOCET IAM with the first 320 and second 350 reservoir simulators, the flow simulator, the economics modeler 330, the a process simulator 335, the injection flow simulator 340, and/or the transportation simulator (collectively “associated simulators”) permits simulation of what-if scenarios, for example a startup on a cold day, an interruption of carbon dioxide supply, a contaminant spike in the stream of produced fluid or CO2 stream, a pressure buildup in a pipeline section, or an examination of limits on water content. Use of the software interface with the associated simulators also permits dynamic simulation under changing conditions as well as fine tuning of the overall model with current operating data. Use of the software interface with the associated simulators also permits process and instrumentation layout, equipment sizing, and/or pipeline sizing. Use of the software interface with the associated simulators could allow adjustments to flow patterns or processing of the CO2 based on conditions or events in the carbon sequestration process. For example, a problem with an injection well might trigger buffering (or if permitted, venting) of processed CO2 upstream of the injection well, choking back or a shut-in of the flow of CO2 upstream of the injection well or a slowdown or shut-in at the carbon processing facility. Simulation of the flow of CO2 within the second reservoir by the second reservoir simulator could monitor the response of the reservoir to the injection of CO2 and might prompt adjustments in the injection rate. Data from the simulation of the flow of CO2 within the second reservoir by the second reservoir simulator sent to the software interface could also help determine whether additional injection wells are needed, whether the second reservoir could be used for additional injection wells or whether a new sequestration reservoir is needed, and well as helping to determine advantageous locations of injection wells or monitoring wells. Problems at the carbon processing facility as monitored by the processing simulator might trigger a shut-in of the production well or buffering of (or if regulations permit, venting of) the CO2 upstream of the carbon processing facility.

There could be a plurality of injection wells each injecting CO2 into one or more reservoirs and/or a plurality of production wells each producing from one or more reservoirs. The plurality of production wells could be associated with one or a plurality of upstream surface production facilities. The plurality of injection wells and/or a plurality of production wells could be associated with one carbon processing facility or a plurality of carbon processing facilities.

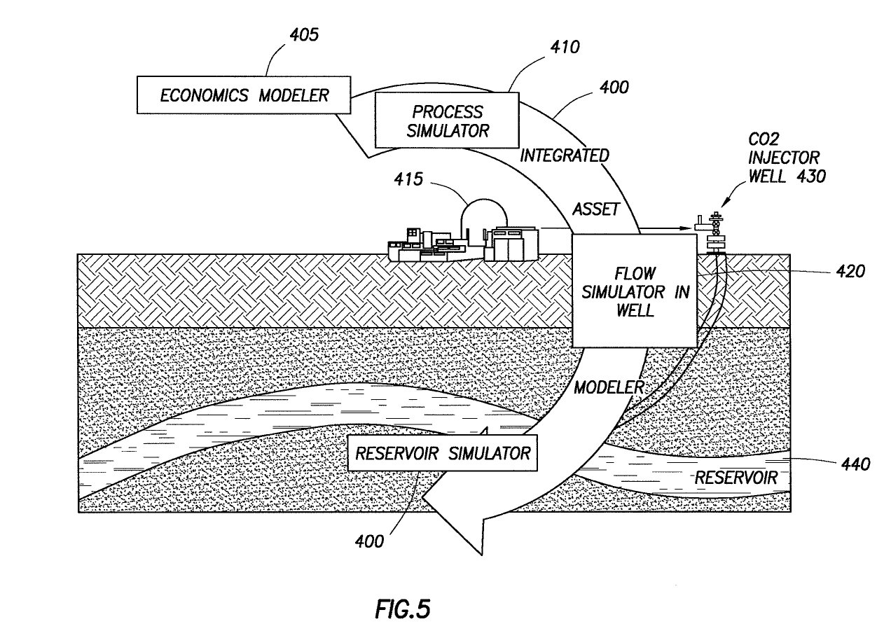

FIG. 5 is a depiction of the CO2 production and sequestration process for anthropogenic CO2, in accord with one embodiment of the present invention. In the situation of anthropogenic CO2, a software interface 400 (such as Avocet IAM) is provided to facilitate an exchange of information among 1) an economics modeler 405; 2) a process simulator 410 (which may be commercially available software such as HYSIS) to model creation of the CO2 form a source 415 (such as from a power plant or industrial source), processing and movement of CO2 at the surface; 3) an injection flow simulator 420 (such as PIPESIM or HYSIS) modeling transport of CO2 from the surface through an injection well 430 and into a sequestration reservoir 435; and 4) a sequestration reservoir simulator 440 (such as ECLIPSE or FrontSim) for modeling the injection and the fate of the CO2 in the sequestration reservoir 435. If CO2 (with or without other fluids) is transported at the surface, a transportation simulator such as PIPESIM may be used. Those skilled in the art will appreciate that each of the sequestration reservoir simulator 440, the economics modeler 405, the process simulator 410, the injection flow simulator 420, and/or the transportation simulator may be implemented on a computer system as described below with respect to FIG. 9.

For the economic modeler 405 of the embodiment of the present invention depicted in FIG. 5, a properly configured Excel file could be used to perform this function. Commercially available software may also be used. PEEP, a commercially available software, while not specifically adapted to CO2 sequestration situations, could be used as the economic modeler 405 in an embodiment of the present invention if “other” is selected as a component when using PEEP, instead of selecting oil or gas as the component. (Other commercial software, as described herein with respect to FIG. 4 for each of the associated simulators, could also be used for the embodiments depicted in FIGS. 5-8.)

Similar to the description with respect to FIG. 4, use of the software interface 400 such as AVOCET IAM with the economics modeler 405, the process simulator 410, the injection flow simulator and the sequestration reservoir simulator 440 (collectively “associated anthropogenic simulators”) permits simulation of what-if scenarios, for example a startup on a cold day, an interruption of carbon dioxide supply, a contaminant spike in the stream of CO2 stream, a pressure buildup in a pipeline section, or an examination of limits on water content. Use of the software interface with the associated anthropogenic simulators also permits dynamic simulation under changing conditions as well as fine tuning of the overall model with current operating data. Use of the software interface with the associated anthropogenic simulators also permits economically advantageous process and instrumentation layout, equipment sizing, and/or pipeline sizing.

Use of the software interface with the associated anthropogenic simulators could allow adjustments to flow patterns or processing of the CO2 based on conditions or events in the carbon sequestration process. For example, a problem with an injection well might trigger buffering (or if permitted, venting) of processed CO2 upstream of the injection well, choking back or a shut-in of the flow of CO2 upstream of the injection well or a slowdown or shut-in at the carbon processing facility. Shut-ins of the carbon processing facility are likely to be strongly disfavored as that might require shut down of the CO2 source, such as a power plant. So in the event of a mechanical problem with an injection well, for example, the processed CO2 intended for the injection well might be diverted to other injection wells. Simulation of the flow of CO2 within the second reservoir by the second reservoir simulator could monitor the response of the reservoir to the injection of CO2 and might prompt adjustments in the injection rate. Data from the simulation of the flow of CO2 within the second reservoir by the second reservoir simulator sent to the software interface could also help determine whether additional injection wells are needed, whether the second reservoir could be used for additional injection wells or whether a new sequestration reservoir is needed, and well as helping to determine advantageous locations of injection wells or monitoring wells. Problems at the carbon processing facility as monitored by the processing simulator might trigger buffering of (or if regulations permit, venting of) the CO2 upstream of the carbon processing facility.

There could be a plurality of injection wells each injecting CO2 into one or more reservoirs and/or a plurality of production wells each producing from one or more reservoirs. The plurality of production wells could be associated with one or a plurality of upstream surface production facilities. The plurality of injection wells and/or a plurality of production wells could be associated with one carbon processing facility or a plurality of carbon processing facilities.

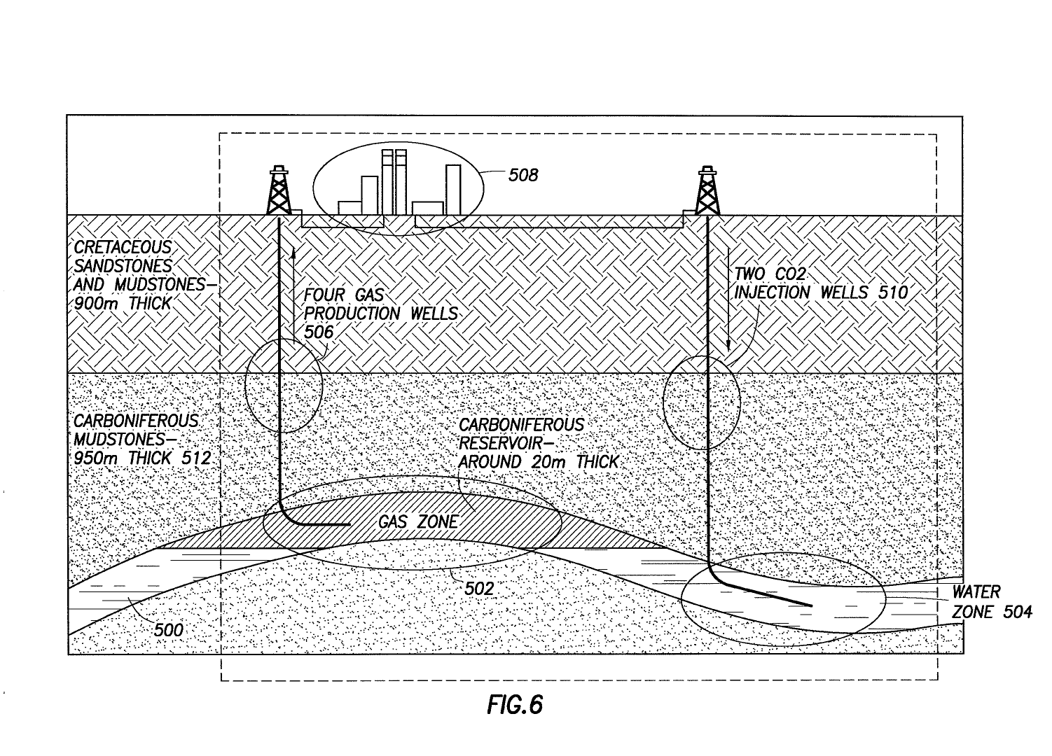

FIG. 6 is a depiction of a representation of an example of a carbon sequestration process involving naturally occurring CO2. In this example, a carboniferous reservoir 500 has a gas zone 502 (including CO2) and a water zone 504. The CO2 is being produced with gas from the gas zone 500, through four production wells 506 (represented by one production well in FIG. 6) to the surface. At the surface, the CO2 is separated from the gas and may be otherwise processed, at processing facilities 508. The CO2 is sent to and into two injection wells (represented by one injection well in FIG. 6), through which the CO2 is injected into the water zone 504 below the gas zone 502 in the carboniferous reservoir 500. A carboniferous mudzone 512 creates a trapping mechanism for fluids in the carboniferous reservoir 500. As the gas and CO2 are produced the water level (which contains water and sequestered CO2 will rise, but the water and CO2, like the gas and CO2, would be trapped by the carboniferous mudzone 512.

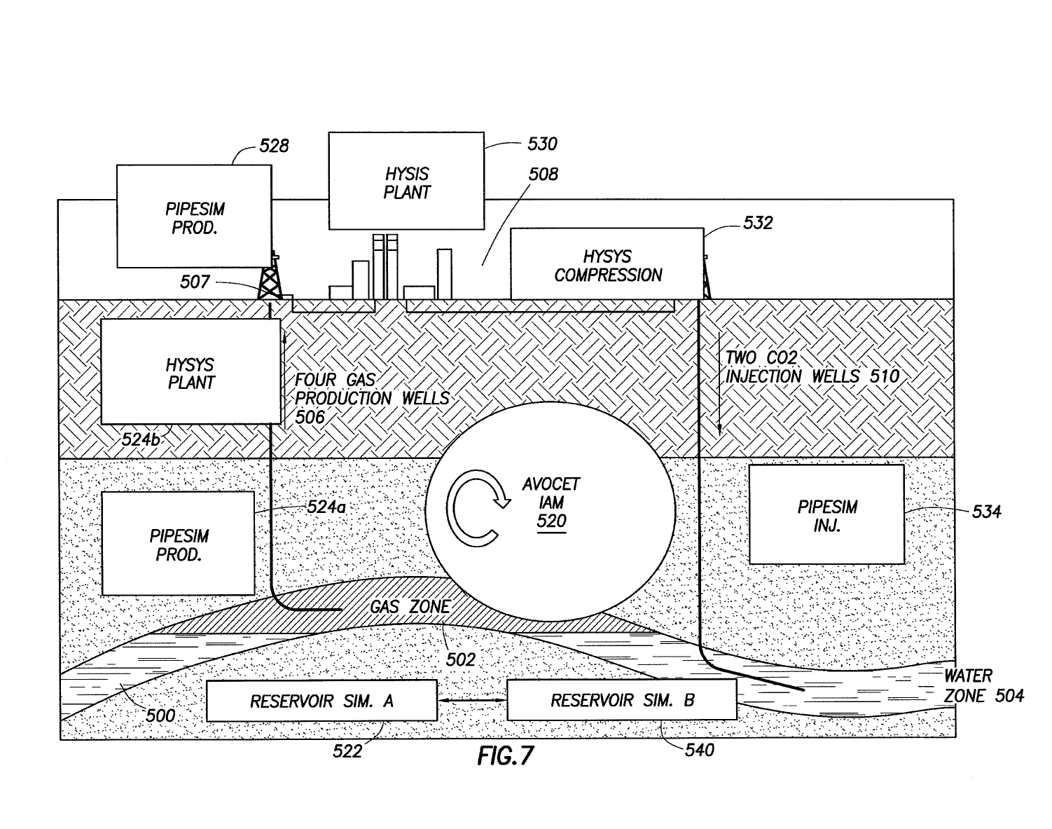

FIG. 7 is a representation of use of one embodiment of the present invention (including commercially available software components) in the carbon sequestration example of FIG. 6. In this embodiment of the present invention, ECLIPSE is used to as a reservoir simulator A 522 which simulates production of CO2 and gas from the gas zone 502. PIPESIM and HYSIS are used as components of a flow simulator 524a, 524b which simulates CO2 and the gas being produced from the gas zone 502 in the producing reservoir through four production wells 506 (represented by one production well in FIG. 7) to the surface. In the embodiment of FIG. 7, PIPESIM is used as a transportation modeler 528 to model transportation of CO2 and gas from production equipment 507 at the surface to a plant 508 for processing. (Some initial processing, such as separation, dehydration and/or heating may also occur at the well site on the surface.) At the plant 508, HYSIS is used as a process simulator 530, 532 for modeling processing and compression of CO2. PIPESIM is used an am injection flow simulator 534, for modeling transport of CO2 from the surface through two injection wells 510 and injection into the water zone 504 of the carboniferous reservoir 500 for sequestration. ECLIPSE is used as a second reservoir simulator B 540 for modeling the injection and the fate of the CO2 in the water zone of the carboniferous (sequestration) reservoir. Avocet IAM is depicted as the software interface 520 that allows exchange of data among the other software programs depicted in this figure. Those skilled in the art will appreciate that each of the reservoir simulator A 522, the flow simulator 524a, 524b, the process simulator 530, 532, the injection flow simulator 534, the second reservoir simulator B 540, and/or the transportation modeler 528 may be implemented on a computer system as described below with respect to FIG. 9.

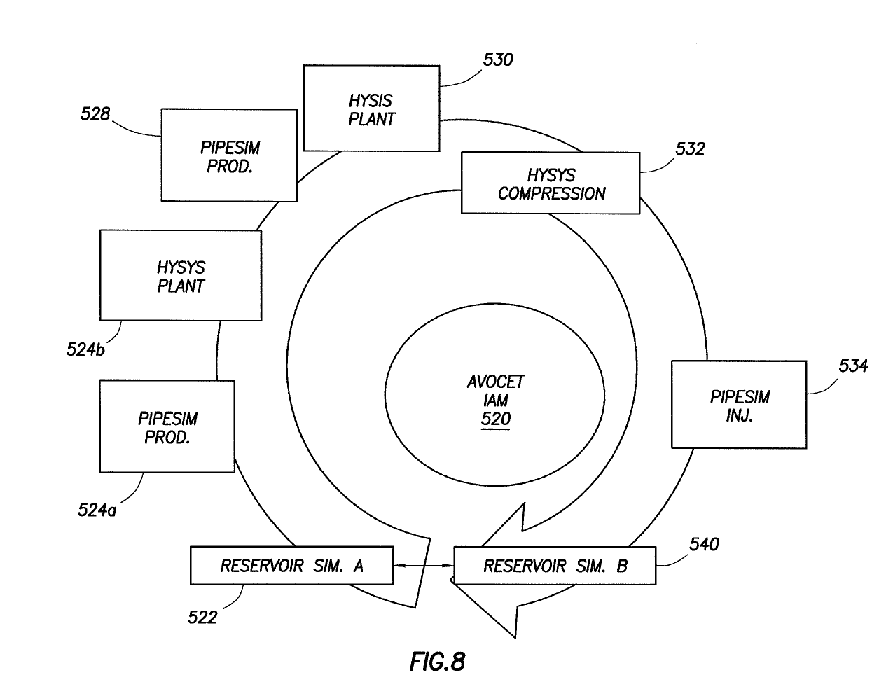

FIG. 8 is a second representation of the embodiment of the present invention depicted in FIG. 7, wherein Avocet IAM 520 is used as the software interface that allows exchange of data among the other software programs used to model the carbon sequestration process (as depicted in FIG. 4): ECLIPSE 522 is used to as the reservoir simulator A which simulates production of CO2 and gas from the gas zone; PIPESIM 524 a and HYSIS 524b used as components of a flow simulator which simulates CO2 and the gas being produced from the producing reservoir through a production well to the surface; PIPESIM 528 used as a transportation modeler to model transportation of CO2 and gas from production equipment at the surface to a plant for processing; HYSIS 530 is used as a process simulator for modeling processing and compression of CO2 at the plant; PIPESIM 534 used an am injection flow simulator, for modeling transport of CO2 from the surface through injection wells into the water zone of the carboniferous reservoir for sequestration; and ECLIPSE 540 used as a second reservoir simulator B for modeling the injection and the fate of the CO2 in the water zone of the carboniferous (sequestration) reservoir. Those skilled in the art will appreciate that each of the reservoir simulator A 522, the flow simulator 524a, 524b, the process simulator 530, 532, the injection flow simulator 534, the second reservoir simulator B 540, and/or the transportation modeler 528 may be implemented on a computer system as described below with respect to FIG. 9.

Embodiments of the invention may be implemented on virtually any type of computer regardless of the platform being used. For example, as shown in FIG. 9, a computer system 600 includes one or more processor(s) 602, associated memory 604 (e.g., random access memory (RAM), cache memory, flash memory, etc.), a storage device 606 (e.g., a hard disk, an optical drive such as a compact disk drive or digital video disk (DVD) drive, a flash memory stick, etc.), and numerous other elements and functionalities typical of today's computers (not shown). The computer system 600 may also include input means, such as a keyboard 608, a mouse 610, or a microphone (not shown). Further, the computer system 600 may include output means, such as a monitor 612 (e.g., a liquid crystal display (LCD), a plasma display, or cathode ray tube (CRT) monitor). The computer system 600 may be connected to a network 614 (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms, now known or later developed. Generally speaking, the computer system 600 includes at least the minimal processing, input, and/or output means necessary to particularly practice embodiments of the invention. Those skilled in the art will appreciate that the computer system 600 described above may be used to implement a simulator for modeling carbon sequestration (e.g., reservoir simulator, flow simulator, process simulator, transportation simulator, injection flow simulator, economics modeler, etc.).

Further, those skilled in the art will appreciate that one or more elements of the aforementioned computer system 600 may be located at a remote location and connected to the other elements over a network 614. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, or any other computer readable storage device.

Although the description herein has focused on CO2 sequestration, one or more embodiments of the present invention may be used for sequestration of other substances such as carbon monoxide, sulfur dioxide or other substances where sequestration may be the disposal means of choice.

1-13. (canceled)

14. A method of facilitating sequestration of anthropogenic carbon dioxide comprising:
a. providing economic analysis for the carbon sequestration process using an economics modeler;
b. simulating processing of the carbon dioxide at a carbon dioxide processing facility using a first process simulator;
c. simulating transportation of carbon dioxide from the carbon dioxide processing facility to an injection well using a transportation simulator;
d. simulating transport of the carbon dioxide from the surface through an injection well and into a first underground reservoir using an injection flow simulator; and
e. facilitating an exchange of data among one or more of the economics modeler, the first process simulator and the injection flow simulator using a software interface to integrate the carbon dioxide sequestration process.

15. The method of claim 14 further comprising simulating transport of the carbon dioxide from a source of the carbon dioxide to the carbon dioxide processing facility using the transportation simulator.

16. The method of claim 14 wherein the first underground reservoir is one selected from a group consisting of a deep saline reservoir and a depleted hydrocarbon reservoir.

17. (canceled)

18. The method of claim 14 further comprising creating one or more what-if scenarios by using the software interface with data from one or more of the economics modeler, the first process simulator, the injection flow simulator, and the transportation simulator and a reservoir simulator.

19. The method of claim 14 further comprising performing dynamic simulation under changing conditions by using the software interface with data from one or more of the economics modeler, the first process simulator, the injection flow simulator, and the transportation simulator and a reservoir simulator.

20. The method of claim 14 further comprising economically advantageously sizing equipment and pipelines for the carbon sequestration operation for a determined anticipated volume of carbon dioxide by using the software interface with data from the economics modeler, and one or more of the first process simulator, the injection flow simulator, and the transportation simulator and a reservoir simulator.

21. (canceled)

22. The method of claim 14 further comprising:
simulating production of a produced fluid containing a hydrocarbon and carbon dioxide from a second underground reservoir to a production well using a reservoir simulator;
simulating production of the produced fluid from entry into the production well from the first underground reservoir through a production well to the surface using a flow simulator; and
simulating separation of the carbon dioxide from one or more other constituents of the produced fluid at an upstream oilfield surface processing facility using a second process simulator.

23. A method of sequestering anthropogenic carbon dioxide comprising:
a. collecting carbon dioxide and preparing the carbon dioxide for sequestration, while monitoring the collection and preparation of the carbon dioxide using a process modeler;
b. selecting a storage site;
c. preparing the storage site;
d. transporting the carbon dioxide to the storage site, measuring the carbon dioxide at one or more points and using a transportation simulator to simulate the transporting of the carbon dioxide;
e. injecting the carbon dioxide into an underground reservoir and simulating the injecting using an injection flow simulator;
f. simulating movement of the carbon dioxide into the underground reservoir using a reservoir simulator;
g. modeling economics of the carbon sequestration process using an economic modeler;
h. using a software interfaces to facilitate exchange of data among two or more of the process modeler, the economic modeler and the injection flow simulator; and
i. using the facilitated data to identify one or more aspects of the carbon sequestration process which require improvement and making one or more improvements addressing such one or more identified aspects.

24-40. (canceled)

41. A system of facilitating a process of sequestration of anthropogenic carbon dioxide comprising:
a. an economics modeler for providing economic analysis for the sequestration process;
b. a first process simulator for simulating processing of the carbon dioxide at a carbon dioxide processing facility;
c. a transportation simulator for simulating transportation of carbon dioxide from the carbon dioxide processing facility to an injection well;
d. an injection flow simulator for simulating transport of the carbon dioxide from the surface through an injection well and into a first underground reservoir; and
e. a software interface for facilitating an exchange of data among one or more of the economics modeler, the first process simulator, the transportation simulator and the injection flow simulator to integrate the sequestration process.

42. (canceled)

43. The system of claim 41 further comprising:
a reservoir simulator for simulating production of a produced fluid containing a hydrocarbon and carbon dioxide from a second underground reservoir to a production well;
a flow simulator for simulating production of the produced fluid from entry into the production well from the first underground reservoir through a production well to the surface;
a second process simulator for simulating separation of the carbon dioxide from one or more other constituents of the produced fluid at an upstream oilfield surface processing facility.

44. The system of claim 41 further comprising use of the software interface with data from one of more of the economics modeler, the first process simulator, the injection flow simulator, the transportation simulator and a reservoir simulator to create one or more what-if scenarios to determine potential problems with the sequestration process.

45. The system of claim 41 further comprising use of the software interface with data from one of more of the economics modeler, the first process simulator, the injection flow simulator, and the transportation simulator and a reservoir simulator to create one or more what-if scenarios to perform dynamic simulation of the sequestration process under changing conditions.

46. The system of claim 41 further comprising use of the software interface with data from the economics modeler and one of more of the first process simulator, the injection flow simulator, and the transportation simulator and a reservoir simulator to economically advantageously size equipment and pipelines for the carbon sequestration operation for a determined anticipated volume of carbon dioxide.

47-56. (canceled)

57. The method of claim 14 wherein there are a plurality of production wells producing from one or more first reservoirs.

58. The method of claim 57 wherein the plurality of production wells are collectively associated with one selected from a group consisting of a single upstream surface production facility and a single carbon processing facility.

59. (canceled)

60. (canceled)

61-62. (canceled)

63. The system of claim 29 wherein there are a plurality of production wells producing from one or more first reservoirs.

64. The system of claim 63 wherein the plurality of production wells are collectively associated with one selected from a group consisting of a single upstream surface production facility and a single carbon processing facility.

65. (canceled)

66. (canceled)

67-71. (canceled)

72. A computer readable storage medium storing instructions for facilitating sequestration of anthropogenic carbon dioxide, the instructions when executed causing a processor to:
a. provide economic analysis for the carbon sequestration process using an economics modeler;
b. simulate processing of the carbon dioxide at a carbon dioxide processing facility using a first process simulator;
c. simulate transportation of carbon dioxide from the carbon dioxide processing facility to an injection well using a transportation simulator;
d. simulate transport of the carbon dioxide from the surface through an injection well and into a first underground reservoir using an injection flow simulator; and
e. facilitate an exchange of data among one or more of the economics modeler, the first process simulator and the injection flow simulator using a software interface to integrate the carbon dioxide sequestration process.

73. The computer readable storage medium of claim 72 wherein the instructions further cause the processor to simulate transport of the carbon dioxide from a source of the carbon dioxide to the carbon dioxide processing facility using the transportation simulator.

74. The computer readable storage medium of claim 72 wherein the instructions further cause the processor to:
simulate production of a produced fluid containing a hydrocarbon and carbon dioxide from a second underground reservoir to a production well using a reservoir simulator;
simulate production of the produced fluid from entry into the production well from the first underground reservoir through a production well to the surface using a flow simulator; and
simulate separation of the carbon dioxide from one or more other constituents of the produced fluid at an upstream oilfield surface processing facility using a second process simulator.
